(19) United States
(12) Patent Application Publication
(10) Pub. No.: US 2016/0258520 A1
(43) Pub. Date: Sep. 8, 2016

(54) IMPELLER HUB THRUST BUSHING

(71) Applicant: Schaeffler Technologies AG & Co. KG, Herzogenaurach (DE)

(72) Inventor: Scott Schrader, Canton, OH (US)

(21) Appl. No.: 14/635,808

(22) Filed: Mar. 2, 2015

(51) Int. Cl. F16H 45/02; F16C 17/12

(52) U.S. Cl. CPC F16H 45/02; F16C 17/12

(57) ABSTRACT

A torque converter is provided. The torque converter includes an impeller including an impeller shell and an impeller hub. The impeller hub extends axially parallel to a center axis of the torque converter. The torque converter also includes a stator adjacent to the impeller and an L-shaped bushing including an axially extending section and a radially extending section. The axially extending section is adjacent the impeller hub and configured for radially centering the impeller hub on the stator shaft. The radially extending section is axially between a radially extending wall of the stator and a radially extending wall of the impeller shell such that the radially extending section provides axial thrust support for the radially extending wall of the stator. A method of forming a torque converter is also provided.

The present disclosure relates generally to torque converter impellers and more specifically to impeller hub bushings.

### BACKGROUND

U.S. Publication No. 2014/0097055 discloses a torque converter with an axially movable turbine used as a piston of a lockup clutch. In some embodiments, the torque converter includes a friction material ring attached to an axial thrust surface of the stator for transmitting a turbine and/or stator thrust load to the impeller.

U.S. Publication No. 2009/0013682 discloses providing an L-shaped bushing between a piston plate and a turbine hub.

### SUMMARY OF THE INVENTION

A torque converter is provided. The torque converter includes an impeller including an impeller shell and an impeller hub. The impeller hub extends axially parallel to a center axis of the torque converter. The torque converter also includes a stator adjacent to the impeller and an L-shaped bushing including an axially extending section and a radially extending section. The axially extending section is adjacent the impeller hub and configured for radially centering the impeller hub on the stator shaft. The radially extending section is axially between a radially extending wall of the stator and a radially extending wall of the impeller shell such that the radially extending section provides axial thrust support for the radially extending wall of the stator.

A method of forming a torque converter is also provided. The method includes providing a stator including an axial thrust surface; providing an L-shaped bushing such that a first axial surface of a radially extending section of the L-shaped bushing contacts the axial thrust surface; and providing an impeller such that the impeller contacts a second axial surface of the radially extending section of the L-shaped bushing and an inner circumferential surface of the impeller contacts an outer circumferential surface of an axially extending section of the L-shaped bushing.

### BRIEF DESCRIPTION OF THE DRAWINGS

The present invention is described below by reference to the following drawings, in which:

FIG. 1a shows a cross-sectional side view of a torque converter in accordance with an embodiment of the present invention;

FIG. 1b schematically shows an enlarged portion of torque converter at an L-shaped bushing thereof; and

FIG. 2 shows a perspective view of the L-shaped bushing connected to an impeller of the torque converter.

### DETAILED DESCRIPTION

The disclosure providing embodiments using an L-shaped bushing to provide radial centering of a pump or impeller hub on a stator shaft, and axial thrust support for a radial wall of a stator casting, eliminating a standard impeller hub bushing and thrust bearing. In one embodiment, the bushing is formed of a metal polymer composite material with grooves.

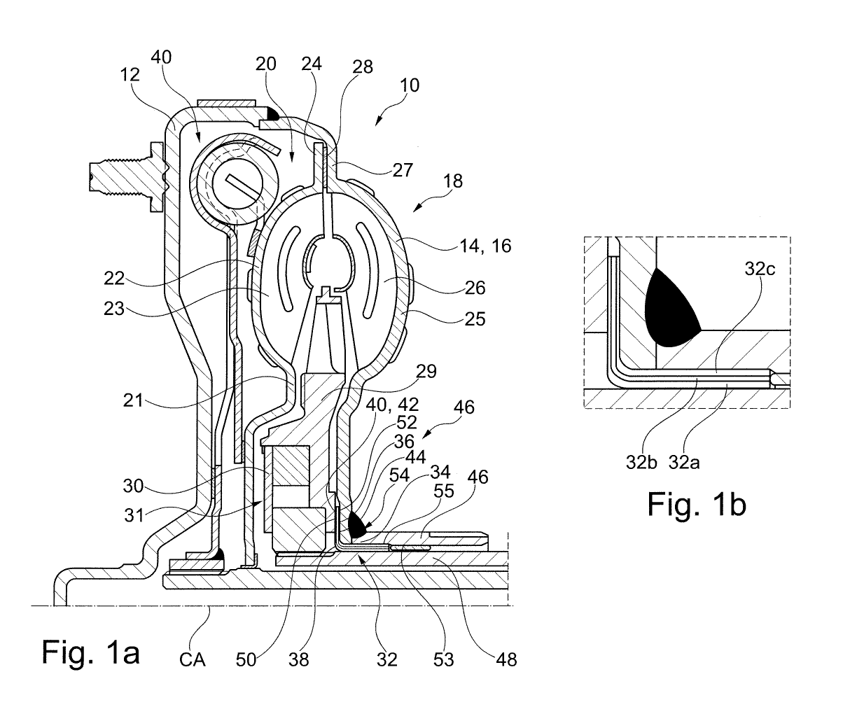

FIG. 1a shows a cross-sectional side view of a torque converter 10 in accordance with an embodiment of the present invention. Torque converter 10 includes a front cover 12 for connecting to a crankshaft of an internal combustion engine and a rear cover 14 forming a shell 16 of an impeller or pump 18. Torque converter 10 also includes a turbine 20 that is configured to be axially slidable toward and away from impeller 18 to engage and disengage impeller 18 so as to form a lockup clutch. Turbine 20 includes a turbine shell 21 including a rounded blade supporting portion 22 for supporting a plurality of turbine blades 23 at a front cover side of the blades 23. Radially outside of blade supporting portion 22, turbine shell 21 includes an outer radial extension 24 radially protruding outwardly from an outer circumference of blade supporting portion 22. Impeller shell 16 includes a rounded blade supporting portion 25 for supporting a plurality of impeller blades 26. Radially outside of blade supporting portion 25, impeller shell 16 includes a radially extending wall 27 radially protruding outwardly from an outer circumference of a blade supporting portion 25. A friction material 28 is bonded onto a surface of outer radial extension 24 for engaging radially extending wall 27. In other embodiments, instead of or in addition to being bonded to outer radial extension 24, friction material 28 may be bonded to radially extending wall 27. Turbine 20 is connected to a damper assembly 40 that is circumferentially drivable by turbine 20 and is positioned between turbine 20 and front cover 12. Torque converter 10 also includes a stator 29 between turbine 20 and impeller 18 and a one-way clutch 31 supporting stator 29. Stator 29 includes a centering plate 30 holding one-way clutch 31 in place within stator 29.

An L-shaped bushing 32 is provided between stator 29 and impeller 18. Specifically, L-shaped bushing 32 includes an axially extending section 34 and radially extending section 36 joined together at an elbow 38. Radially extending section 36 is axially between an axial thrust surface 40 formed on a radially extending wall 42 of stator 29 and a radially extending wall 44 of impeller shell 16 at a radially inner end 46 of impeller 16. Radially extending section 36 provides axial thrust support for axial thrust surface 40 at radially extending wall 42. Radially extending section 36 is configured to allow fluid flow in a radial direction between stator 29 and impeller 18. More specifically, radially extending section 36 includes radially extending grooves at an axial surface thereof that are configured to allow fluid flow in the radial direction between radially extending wall 42 of stator 29 and radially extending wall 44 of impeller shell 16.

FIG. 1b schematically shows an enlarged portion of torque converter 10 at L-shaped bushing 32. In a preferred embodiment, L-shaped bushing 32 is formed of a metal polymer composite material with a polymer bearing layer 32a forming axial thrust surface 40. The metal of the metal polymer composite includes an intermediate layer 32b and a backing layer 32c. In one embodiment, the metal polymer composite material includes a porous spherical structure of sintered bronze, which forms layer 32b, overlaid to a steel backing or a copper plate steel backing, which forms layer 32c, with the porous spherical structure being impregnated with a bearing layer of PTFE filled with evenly dispersed inorganic filler and polymeric fibers, which forms layer 32a. In another embodiment, the metal polymer composite material includes a porous sintered bronze layer, which forms layer 32b, overlaid to a low carbon steel backing, which forms layer 32c, with the porous layer being impregnated with a bearing layer 32a of PTFE with fluoropolymer and other fillers, with the bearing layer 32a for example including CaF2, fluoropolymer and inorganic fillers.

Axially extending section 34 is radially between a hub 46 of impeller 18 and a stator shaft 48. Impeller hub 46 extends axially parallel to a center axis CA of the torque converter 10. Stator shaft 48 is drivingly connected to stator 29 via one-way clutch 31. Stator shaft 48 extends parallel to impeller hub 46. Axially extending section 34 radially centers impeller hub 46 on stator shaft 48. Axially extending section 34 is configured to allow fluid flow in an axial direction between stator shaft 48 and impeller hub 46. More specifically, axially extending section 34 includes axially extending grooves at a radial surface thereof that are configured to allow fluid flow in the axial direction between stator shaft 48 and impeller hub 46.

L-shaped bushing 32 is provided such that a first axial surface 50 of a radially extending section 36 contacts axial thrust surface 40 and impeller 18 is provided such that radially extending wall 44 of impeller shell 16 contacts a second axial surface 52 of radially extending section 36. Also, impeller 18, via an inner circumferential surface 53 of impeller hub 46, contacts an outer circumferential surface 55 of axially extending section 34. Impeller 18 includes an L-shaped transition 54 formed by impeller shell 16, at radially inner end 46, and impeller hub 46. L-shaped transition 54 rests in L-shaped bushing 32.

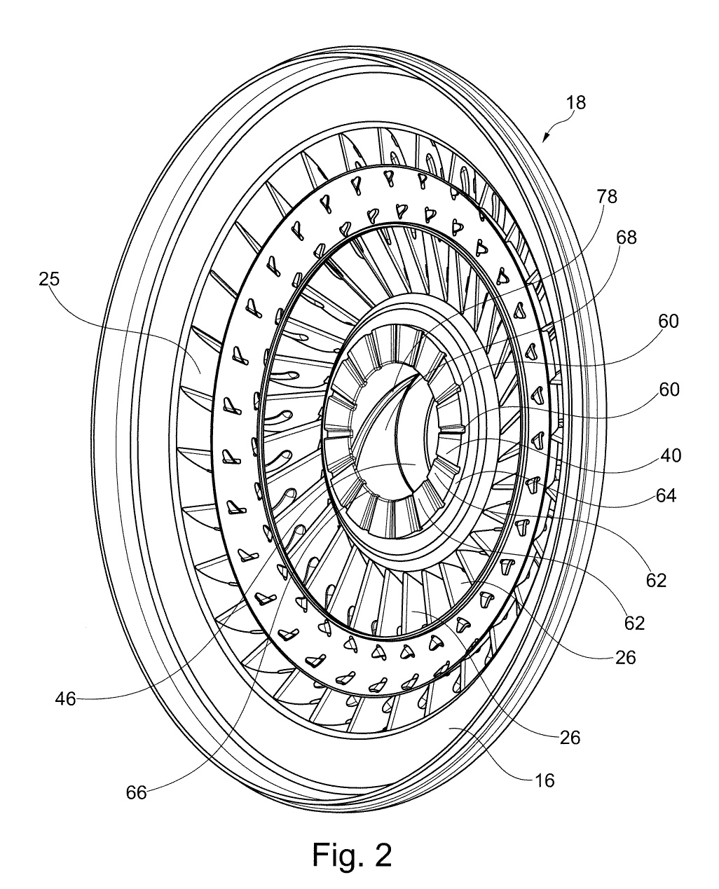

FIG. 2 shows a perspective view of bearing 32 connected to impeller 18 radially inside of impeller blades 26, which are connected rounded blade supporting portion 25 of impeller 26. As shown in FIG. 2, bearing 32 includes a plurality of radially extending grooves 60 axially recessed with respect to axial thrust surface 40 dissecting axial thrust surface 40 includes a plurality of segments 62 circumferentially spaced from each other by grooves 60. Grooves 60 each extend from an outer circumferential surface 64 to an inner circumferential surface 66 of radially extending section 36. An inner circumferential surface 68 of axially extending section 34 includes at least one axially extending groove 70 formed therein extending along an entire axial length of inner circumferential surface 68. In this embodiment, groove 70 extends both circumferentially and axially and connects with one of grooves 60 for fluid flow therethrough.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A torque converter comprising:
an impeller including an impeller shell and an impeller hub, the impeller hub extending axially parallel to a center axis of the torque converter;
a stator adjacent to the impeller; and
an L-shaped bushing including an axially extending section and a radially extending section, the axially extending section being adjacent the impeller hub and configured for radially centering the impeller hub on a transmission stator shaft, the radially extending section being axially between a radially extending wall of the stator and a radially extending wall of the impeller shell such that the radially extending section provides axial thrust support for the radially extending wall of the stator.

2. The torque converter as recited in claim 1 wherein the radially extending section of the L-shaped bushing is configured to allow fluid flow in a radial direction between the stator and the impeller.

3. The torque converter as recited in claim 2 wherein the radially extending section of the L-shaped bushing includes radially extending grooves at an axial surface thereof, the radially extending grooves configured to allow fluid flow in the radial direction between the stator and the impeller.

4. The torque converter as recited in claim 1 wherein the axially extending section of the L-shaped bushing is configured to allow fluid flow in an axial direction between the stator shaft and the impeller.

5. The torque converter as recited in claim 4 wherein the axially extending section of the L-shaped bushing includes at least one axially extending groove at a radial surface thereof, the at least one axially extending groove configured to allow fluid flow in the axial direction between the stator shaft and the impeller hub.

6. The torque converter as recited in claim 1 wherein the L-shaped bushing is formed of a metal polymer composite material.

7. The torque converter as recited in claim 1 wherein the impeller includes an L-shaped transition formed by the impeller shell and the impeller hub, the L-shaped transition resting in the L-shaped bushing.

8. The torque converter as recited in claim 1 further comprising an axially movable turbine for engaging and disengaging the impeller shell so as to form a lockup clutch.

9. The torque converter as recited in claim 8 wherein the turbine includes turbine blades, a rounded portion supporting the turbine blades and radially outward extension extending radially from the rounded portion, the radially outward extension engaging and disengaging the impeller shell.

10. The torque converter as recited in claim 9 wherein the impeller shell includes a radially extending wall for engagement and disengagement by the radially outward extension of the turbine shell, at least one of the radially outward extension of the turbine shell and the radially extending section of the impeller shell includes a friction material attached to an axial surface thereof for effecting the engagement of the impeller shell by the turbine shell.

10. A method of forming a torque converter comprising:
providing a stator including an axial thrust surface;
providing an L-shaped bushing such that a first axial surface of a radially extending section of the L-shaped bushing contacts the axial thrust surface; and
providing an impeller such that the impeller contacts a second axial surface of the radially extending section of the L-shaped bushing and an inner circumferential surface of the impeller contacts an outer circumferential surface of an axially extending section of the L-shaped bushing.

11. The method as recited in claim 10 further comprising forming the radially extending section of the L-shaped bushing to include radially extending grooves at an axial surface thereof, the radially extending grooves configured to allow fluid flow in the radial direction between the stator and the impeller.

11. The method as recited in claim 10 further comprising forming the axially extending section of the L-shaped bushing to include at least one axially extending groove at a radial surface thereof, the at least one axially extending groove configured to allow fluid flow in the axial direction between a transmission stator shaft and the impeller hub.

12. The method as recited in claim 10 further comprising forming the L-shaped bushing out of a metal polymer composite material.

13. The method as recited in claim 10 wherein the impeller includes an L-shaped transition formed by the impeller shell and the impeller hub, the impeller being provided such that the L-shaped transition rests in the L-shaped bushing.

14. The method as recited in claim 10 further comprising providing a turbine including turbine blades, a rounded portion supporting the turbine blades and a radially outward extension extending radially from the rounded portion, the radially outward extension configured for engaging and disengaging the impeller shell.
